(19) United States
(12) Patent Application Publication
(10) Pub. No.: US 2023/0302461 A1
(43) Pub. Date: Sep. 28, 2023

(54) Magnetic Stand And Magnetic Separation Method

(71) Applicant: SEIKO EPSON CORPORATION, Tokyo (JP)

(72) Inventors: Fumio TAKAGI, Chino (JP); Hiroshi TAKIGUCHI, Matsumoto (JP)

(21) Appl. No.: 18/187,918

(22) Filed: Mar. 22, 2023

(30) Foreign Application Priority Data
Mar. 23, 2022 (JP) 2022-046534

(51) Int. Cl. B03C 1/02; B03C 1/01

(52) U.S. Cl. CPC B03C 1/02; B03C 1/01; B03C 2201/18; B03C 2201/20; B03C 2201/22

(57) ABSTRACT

A magnetic stand includes: a base having an insertion hole into which a container is to be inserted, the insertion hole extending along a first axis; and a magnet provided on the base and having a magnetization that applies a magnetic field to the insertion hole. The magnet is disposed such that magnetic poles thereof face directions different from that of the container. When a plane including the first axis and determined such that a normal line of the plane is orthogonal to the first axis and passes through a center of the magnet is taken as a reference plane, and the magnetization is projected onto the reference plane, an angle formed by the first axis and the magnetization projected onto the reference plane is more than 0° and 90° or less.

The present application is based on, and claims priority from JP Application Serial Number 2022-046534, filed Mar. 23, 2022, the disclosure of which is hereby incorporated by reference herein in its entirety.

### BACKGROUND

### 1. Technical Field

The present disclosure relates to a magnetic stand and a magnetic separation method.

### 2. Related Art

In recent years, in diagnosis in the medical field and in the field of life science, there has been an increasing demand for testing biological substances. Among biological substance testing methods, polymerase chain reaction (PCR) is a method of extracting nucleic acids such as deoxyribonucleic acid (DNA) and ribonucleic acid (RNA), and specifically amplifying and detecting the nucleic acids. In a process of testing such a biological substance, it is necessary to first extract a substance to be tested from a specimen. For the extraction of the biological substance, magnetic separation using magnetic beads is widely used. In magnetic separation, a biological substance is extracted by applying a magnetic field using magnetic beads having a function of carrying the biological substance to be extracted. Specifically, after the magnetic beads having the function of carrying the substance to be tested on surfaces of the magnetic beads are dispersed in a dispersion medium, the obtained dispersion liquid is attached to a magnetic field generation device such as a magnetic stand, and ON/OFF of magnetic field application is repeated a plurality of times. Accordingly, the substance to be tested is extracted. Since such magnetic separation is a method of separating and collecting magnetic beads by a magnetic force, a rapid separation operation can be performed.

The magnetic separation is used not only in the extraction performed by the PCR method but also in fields of protein purification, separation and extraction of exosomes and cells, or the like.

In magnetic separation, a magnetic stand is used. The magnetic stand has a function of holding a container and a function of applying a magnetic field to the container. For example, JP-A-2014-018692 discloses a magnetic stand including a base having a holding hole into which a container is to be inserted, and a permanent magnet provided on the base. In the magnetic stand, the permanent magnet is disposed such that an N pole thereof faces the container and an S pole thereof faces an opposite side.

When a magnetic field is applied to a container containing magnetic beads, the magnetic beads in the container are arranged along a direction of the magnetic field. Therefore, when the permanent magnet is disposed as described in JP-A-2014-018692, the magnetic beads are arranged in a needle shape along a radial direction of the container. Such a phenomenon in which the magnetic beads are arranged in the needle shape is also referred to as a “spike phenomenon”. When the spike phenomenon occurs, a solution is likely to be held between the magnetic beads arranged in the needle shape. As a result, separability between the magnetic beads and the solution is reduced, and impurities are likely to be mixed into an extracted biological substance. That is, washing efficiency of the biological substance may be lowered and purity of the extracted biological substance may be lowered. The above problems may occur when the direction of the magnetic field is not appropriate even if the spike phenomenon does not occur.

### SUMMARY

A magnetic stand according to an application example of the present disclosure includes: a base having an insertion hole into which a container is to be inserted, the insertion hole extending along a first axis; and a magnet provided on the base and having a magnetization that applies a magnetic field to the insertion hole. The magnet is disposed such that magnetic poles thereof face directions different from that of the container. When a plane including the first axis and determined such that a normal line of the plane is orthogonal to the first axis and passes through a center of the magnet is taken as a reference plane, and the magnetization is projected onto the reference plane, an angle formed by the first axis and the magnetization projected onto the reference plane is more than 0° and 90° or less.

A magnetic separation method according to the application example of the present disclosure includes: a magnetic separation step of separating magnetic beads from a liquid by applying a magnetic field to a container containing the magnetic beads and the liquid to fix the magnetic beads to an inner wall of the container; and a liquid discharge step of discharging the liquid by a solution binding tool in a state in which the magnetic beads and the liquid are separated from each other. Magnetic poles that generate the magnetic field face directions different from that of the container. The magnetic field is set such that, when an axis of the container is taken as a second axis and magnetic field lines representing the magnetic field are projected onto a plane including the second axis, an angle formed by a projected magnetic field line and the second axis is more than 0° and 90° or less.

### BRIEF DESCRIPTION OF THE DRAWINGS

FIG. 1 is a perspective view showing a magnetic stand according to an embodiment.

FIG. 2 is a cross-sectional view of the magnetic stand shown in FIG. 1 taken along an X-Z plane.

FIG. 3 is a cross-sectional view of the magnetic stand shown in FIG. 1 taken along an X-Y plane.

FIG. 4 is a step diagram showing a biological substance extraction method including a magnetic separation method according to the embodiment.

FIG. 5 is a schematic view showing the biological substance extraction method shown in FIG. 4.

FIG. 6 is a schematic view showing the biological substance extraction method shown in FIG. 4.

FIG. 7 is a schematic view showing an example in which a direction of a magnetic field applied to a container is set to a direction of the container (an example in which factor (a) is not satisfied).

FIG. 8 is a schematic view showing the example in which the direction of the magnetic field applied to the container is set to the direction of the container (the example in which factor (a) is not satisfied).

FIG. 9 is a schematic view showing an angle θ2 formed by a second axis AX2 and a projected magnetic field line Lm′ when magnetic field lines Lm are projected onto a plane P2 including the second axis AX2 of the container.

FIG. 10 is a schematic view showing an example in which the angle θ2 formed by the second axis AX2 and the projected magnetic field line Lm′ is 0° when the magnetic field lines Lm are projected onto the plane P2 including the second axis AX2 of the container (an example in which factor (b) is not satisfied).

FIG. 11 is a schematic view showing the example in which the angle θ2 formed by the second axis AX2 and the projected magnetic field line Lm′ is 0° when the magnetic field lines Lm are projected onto the plane P2 including the second axis AX2 of the container (the example in which factor (b) is not satisfied).

FIG. 12 is a schematic view showing an angle θ1 formed by a first axis AX1 and a direction of a projected magnetization M′ when a magnetization M of a magnet is projected onto a plane P1 including the first axis AX1 of an insertion hole of the magnetic stand.

FIG. 13 is a diagram of the container inserted into the insertion hole shown in FIG. 12 when viewed from the magnet.

FIG. 14 is a graph for comparing residual liquid amounts in Example 1 and comparative examples.

FIG. 15 is a graph for comparing residual liquid amounts in Examples 1 to 5.

### DESCRIPTION OF EXEMPLARY EMBODIMENTS

Hereinafter, a preferred embodiment of a magnetic stand and a magnetic separation method according to the present disclosure will be described in detail with reference to the accompanying drawings.

### 1. Magnetic Stand

First, a magnetic stand according to an embodiment will be described.

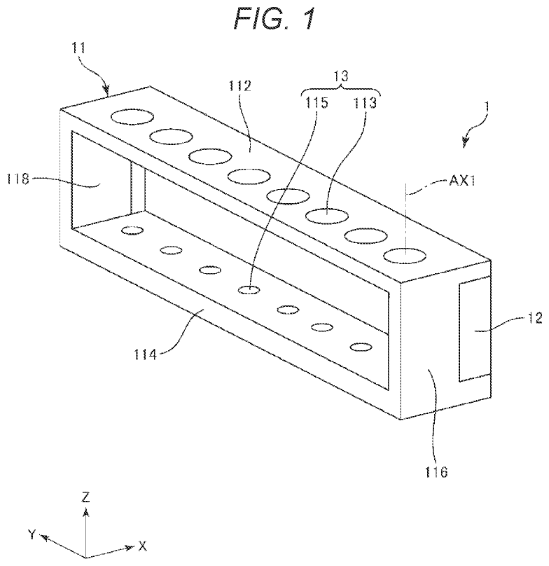

FIG. 1 is a perspective view showing a magnetic stand 1 according to the embodiment. In the drawings of the present application, an X axis, a Y axis, and a Z axis are set as three axes orthogonal to one another. Each axis is represented by an arrow, a tip end side is “plus”, and a base end side is “minus”. In the following description, for example, an “X-axis direction” includes both an X-axis plus direction and an X-axis minus direction. In the following description, a Z-axis plus side may be referred to as “upper” and a Z-axis minus side may be referred to as “lower”.

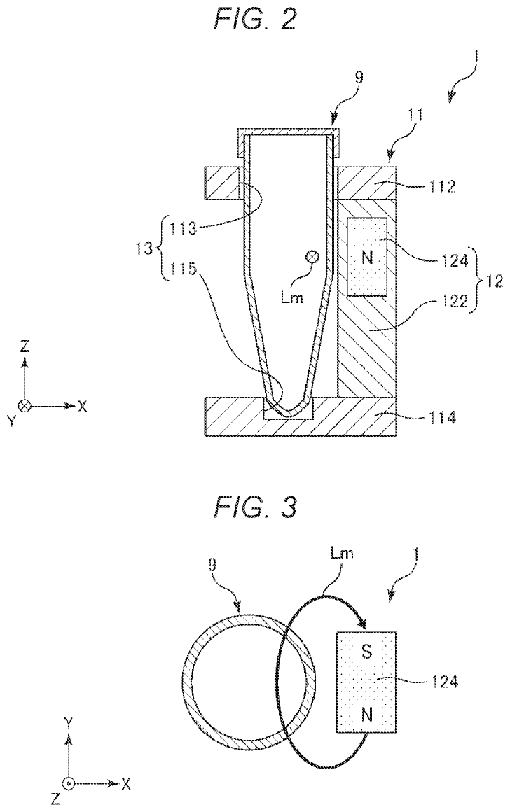

FIG. 2 is a cross-sectional view of the magnetic stand 1 shown in FIG. 1 taken along an X-Z plane. FIG. 3 is a cross-sectional view of the magnetic stand 1 shown in FIG. 1 taken along an X-Y plane.

The magnetic stand 1 shown in FIG. 1 is a magnetic field generation device that holds a container 9 such as a microtube as shown in FIG. 2 and applies an external magnetic field to a sample. The magnetic stand 1 includes a stand 11 (base) and a magnet plate 12 having a magnet 124. By applying an external magnetic field generated by the magnet 124, the magnetic beads and a liquid contained in the container 9 can be magnetically separated from each other. Specifically, the external magnetic field is applied to the magnetic beads to fix the magnetic beads to an inner wall surface of the container 9. Accordingly, the magnetic beads in a solid phase and the liquid in a liquid phase can be separated from each other.

### 1.1. Stand

The stand 11 shown in FIG. 1 includes an upper plate 112, a lower plate 114, and side plates 116 and 118 that couple the upper plate 112 and the lower plate 114 to each other. The upper plate 112 and the lower plate 114 each have a plate shape extending along the X-Y plane. The side plates 116 and 118 each have a plate shape extending along the X-Z plane.

The upper plate 112 has a plurality of through holes 113. The through holes 113 pass through the upper plate 112 along the Z axis. The through holes 113 are arranged at predetermined intervals along the Y axis.

The lower plate 114 is disposed below the upper plate 112 to be spaced apart from the upper plate 112, and has a plurality of recesses 115. The recesses 115 are open upward. The recesses 115 are arranged at predetermined intervals along the Y axis. Further, positions of the through holes 113 and positions of the recesses 115 in the Y-axis direction coincide with each other. Accordingly, one through hole 113 and one recess 115 form a pair, thereby forming an insertion hole 13. The insertion hole 13 is a hole into which the container 9 is to be inserted, and extends along a first axis AX1. When the container 9 is inserted into the through hole 113 from above, the container 9 is held by the through hole 113 and the recess 115. That is, the container 9 is made to stand against the insertion hole 13. Accordingly, a posture of the container 9 can be held along the first axis AX1, and a distance between the container 9 and the magnet plate 12 can be maintained in a sufficiently close state. Since the stand 11 has the plurality of insertion holes 13, the stand 11 can hold a plurality of containers 9 at the same time.

An inner wall surface of the through hole 113 shown in FIG. 1 has a continuous annular shape to surround the first axis AX1. The present disclosure is not limited thereto, and a part of the shape may be cut off. Similarly, an inner wall surface of the recess 115 shown in FIG. 1 also has a continuous annular shape. The present disclosure is not limited thereto, and a part of the shape may be cut off. The recess 115 may penetrate the lower plate 114. Further, when the posture of the container 9 can be held by the through hole 113 alone, the recess 115 may be omitted.

The first axis AX1 shown in FIG. 1 is parallel to the Z axis, and may be inclined with respect to the Z axis.

The side plate 116 couples an end portion of the upper plate 112 on a Y-axis minus side and an end portion of the lower plate 114 on the Y-axis minus side. The side plate 118 couples an end portion of the upper plate 112 on a Y-axis plus side and an end portion of the lower plate 114 on the Y-axis plus side. The upper plate 112, the lower plate 114, the side plate 116, and the side plate 118 constitute a frame body.

A constituent material of the stand 11 is not particularly limited as long as the material is a non-magnetic material. For example, a resin material such as ABS, polypropylene, or nylon, or a metal material such as an aluminum alloy is used.

### 1.2. Magnet Plate

The magnet plate 12 is located on an X-axis plus side of the insertion hole 13 and is provided between the upper plate 112 and the lower plate 114. As shown in FIG. 2, the magnet plate 12 includes a back plate 122 and the magnet 124 provided in the back plate 122.

The back plate 122 has a plate shape extending along a Y-Z plane. The back plate 122 supports a plurality of magnets 124. The magnets 124 are arranged at predetermined intervals along the Y axis. Further, positions of the magnets 124 and the positions of the insertion holes 13 in the Y-axis direction coincide with each other. Accordingly, since one insertion hole 13 and one magnet 124 form a pair, the external magnetic field from the magnet 124 can be applied to the container 9 inserted into the insertion hole 13. Since the back plate 122 is located between the upper plate 112 and the lower plate 114, the magnets 124 can be brought close to the insertion holes 13. Accordingly, the external magnetic field applied to the container 9 can be strengthened.

The magnet 124 may be an electromagnet, and is preferably a permanent magnet. Accordingly, a power supply for the magnetic stand 1 is unnecessary, and size reduction and weight reduction are facilitated. Since portability of the magnetic stand 1 is improved, a degree of freedom of an installation place is increased.

Examples of the permanent magnet include a neodymium iron boron magnet, a samarium-cobalt magnet, a ferrite magnet, and an alnico magnet. Among these, since a sufficient magnetic field can be generated with a smaller size, a neodymium iron boron magnet is preferably used. The neodymium iron boron magnet is preferably coated with nickel plating or the like from the viewpoint of securing reliability over time such as corrosion resistance.

A magnetic flux density on a surface of the magnet 124 is preferably 50 mT or more, and more preferably 200 mT or more. Accordingly, a moving speed of the magnetic beads in magnetic separation can be increased, and the fixed magnetic beads can be prevented from falling off. The surface magnetic flux density of the magnet 124 is measured by, for example, a Gaussian meter using a Hall element.

A size of the magnet 124 is appropriately selected according to a size of the container 9 and the like. Therefore, it is preferable that the size of the magnet 124 is appropriately set according to a size of the insertion hole 13. A specific size will be described later.

In a state in which the container 9 is inserted into the insertion hole 13, a part of the back plate 122 may or may not be interposed between the container 9 and the magnet 124 as shown in FIG. 2.

FIGS. 2 and 3 show a state in which magnetic field lines Lm generated from the magnet 124 enter the container 9. The magnet 124 shown in FIGS. 2 and 3 is disposed such that the N pole thereof faces the Y-axis minus side and the S pole thereof faces the Y-axis plus side. Accordingly, as shown in FIGS. 2 and 3, the magnetic field lines Lm generated from the magnet 124 contain a large number of components parallel to the X-Y plane. The external magnetic field represented by the magnetic field lines Lm acts on the magnetic beads (not shown) accommodated in the container 9.

### 2. Biological Substance Extraction Method

Next, a biological substance extraction method including the magnetic separation method according to the embodiment will be described.

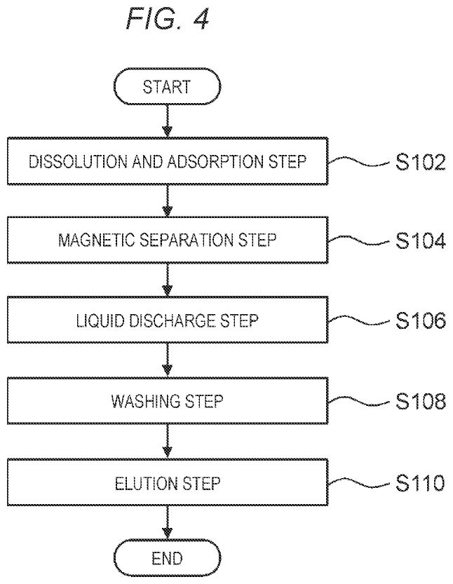

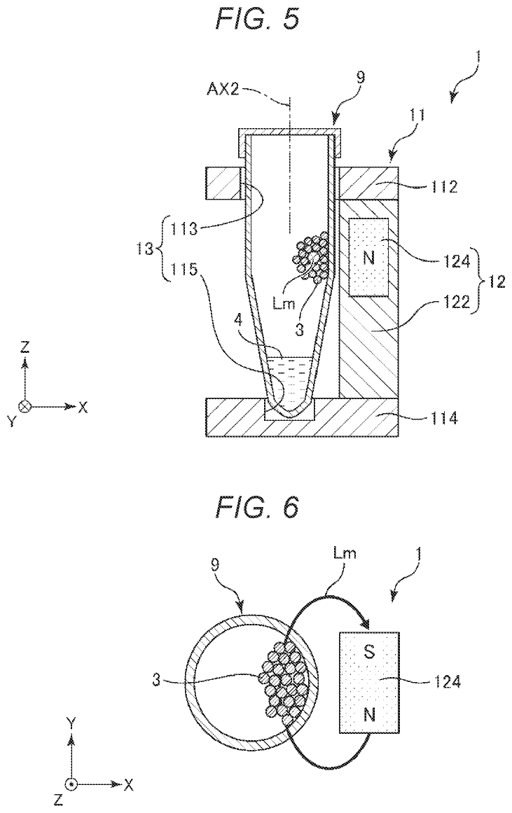

FIG. 4 is a step diagram showing the biological substance extraction method including the magnetic separation method according to the embodiment. FIGS. 5 and 6 are schematic views showing the biological substance extraction method shown in FIG. 4.

The biological substance extraction method shown in FIG. 4 includes a lysis and binding step S102, a magnetic separation step S104, a liquid discharge step S106, a washing step S108, and an elution step S110. Among these, the magnetic separation step S104 and the liquid discharge step S106 constitute the magnetic separation method according to the embodiment.

Examples of the biological substance to be extracted by the biological substance extraction method include nucleic acids such as DNA and RNA, proteins, various cells such as cancer cells, peptides, and viruses. The nucleic acids may be present in a state of being contained in, for example, a biological sample such as cells or biological tissue, viruses, or bacteria. In the biological substance extraction method shown in FIG. 4, such a biological substance is extracted through the steps of lysis and binding, separation, washing, and elution. A procedure of the extraction method is usually determined for each magnetic bead dispersion liquid provided as a reagent or each target biological substance, and is usually clearly indicated by a provider. Such a procedure is generally referred to as an “extraction protocol”.

Hereinafter, each step will be sequentially described. In the following description, a case where the biological substance is a nucleic acid will be described as an example. In the following description, a case where the magnetic stand 1 described above is used in the magnetic separation method will be described, but a magnetic field generation device other than the magnetic stand 1 may be used.

### 2.1. Lysis and Binding Step

In the lysis and binding step S102, first, a sample containing the nucleic acids is put into the container 9 shown in FIGS. 5 and 6. A dispersion liquid containing the magnetic beads 3 and a lysis and binding solution are further put into the container 9. Then, contents contained in the container 9 are mixed. Since the nucleic acids are usually encapsulated in a cell membrane or a nucleus, a so-called outer shell of the cell membrane or the nucleus is first dissolved and removed by a lysis action of the lysis and binding solution to extract the nucleic acids. Thereafter, the nucleic acids are adsorbed to the magnetic beads 3 by an adsorption action of the lysis and binding solution.

As the lysis and binding solution, for example, a liquid containing a chaotropic substance is used. The chaotropic substance generates chaotropic ions in an aqueous solution, reduces an interaction of water molecules, thereby destabilizing the structure, and contributes to the adsorption of nucleic acids to the magnetic beads 3. Examples of the chaotropic substance present as the chaotropic ions in the aqueous solution include guanidine thiocyanate, guanidine hydrochloride, sodium iodide, potassium iodide, and sodium perchlorate. Among these, guanidine thiocyanate or guanidine hydrochloride, which has a strong protein denaturation effect, is preferably used.

A concentration of the chaotropic substance in the lysis and binding solution varies depending on the chaotropic substance, and is preferably, for example, 1.0 M or more and 8.0 M or less. In particular, when guanidine thiocyanate is used, the concentration thereof is preferably 3.0 M or more and 5.5 M or less. Further, in particular, when guanidine hydrochloride is used, the concentration thereof may be 4.0 M or more and 7.5 M or less.

The lysis and binding solution may contain a surfactant. The surfactant is used to destroy a cell membrane or modify a protein contained in a cell. The surfactant is not particularly limited. Examples thereof include nonionic surfactants such as polyoxyethylene sorbitan monolaurate, triton-based surfactants, and Tween-based surfactants, and anionic surfactants such as sodium N-lauroyl sarcosinate. Among these, the nonionic surfactant is preferably used. Due to the nonionic surfactant, when the nucleic acids after extraction are analyzed, influence of the ionic surfactant is reduced. As a result, it is possible to perform analysis by an electrophoresis method and broaden options for analysis methods.

A concentration of the surfactant in the lysis and binding solution is not particularly limited, and is preferably 0.1 mass % or more and 2.0 mass % or less.

The lysis and binding solution may contain at least one of a reducing agent or a chelating agent. Examples of the reducing agent include 2-mercaptoethanol and dithiothreitol. Examples of the chelating agent include disodium dihydrogen ethylenediaminetetraacetate (EDTA) dihydrate.

A concentration of the reducing agent in the lysis and binding solution is not particularly limited and is preferably 0.2 M or less. A concentration of the chelating agent in the lysis and binding solution is not particularly limited and is preferably 0.2 mM or less.

A pH of the lysis and binding solution is not particularly limited and is preferably neutral at 6 or more and 8 or less. In order to adjust the pH, tris(hydroxy) aminomethane, HCl, or the like may be added as a buffer solution.

In the lysis and binding step S102, contents contained in the container 9 are stirred by a vortex mixer, hand shaking, or the like as necessary. A stirring time is not particularly limited, and may be 5 seconds or more and 40 minutes or less.

The magnetic beads 3 are not particularly limited as long as the magnetic beads are magnetic particles capable of adsorbing the nucleic acids while having residual magnetization. For example, the magnetic beads 3 contain fine particles of ferrite or magnetic metal particles.

Among these, magnetic metal particles are preferably used. Since the magnetic metal particles have high saturation magnetization, the moving speed of the magnetic beads 3 can be improved in the magnetic separation. Accordingly, a time required for the magnetic separation can be shortened.

Examples of a composition of the magnetic metal particles include an alloy containing Fe as a main component (Fe-based alloy). Specific examples thereof include a Fe—Co-based alloy, a Fe—Ni-based alloy, a Fe—Co—Ni-based alloy, a Fe—Si-based alloy, and a Fe—Si—Cr-based alloy.

A metal structure constituting the magnetic metal particles can take various forms such as a crystalline structure, an amorphous structure, and a nanocrystal structure. In particular, by using the amorphous structure or the nanocrystalline structure, a coercive force Hc becomes a low value, and dispersibility of the magnetic beads 3 can be improved.

The magnetic bead 3 preferably includes a coating layer that coats a surface of the magnetic metal particle. The coating layer has a function of capturing a biological substance to be extracted. Examples of a constituent material of the coating layer include, in addition to silicon oxide, a composite oxide or a composite containing silicon and one oxide or two or more oxides selected from the group consisting of Al, Ti, V, Nb, Cr, Mn, Sn, and Zr.

An average particle diameter of the magnetic beads 3 is preferably 0.5 μm or more and 50 μm or less, and more preferably 2 μm or more and 20 μm or less. Accordingly, the magnetic beads 3 can be uniformly dispersed in the liquid, and a sufficient amount of nucleic acids can be adsorbed to the surfaces of the magnetic beads 3. Accordingly, extraction efficiency and detection accuracy of the nucleic acids can be improved.

### 2.2. Magnetic Separation Step

In the magnetic separation step S104, an external magnetic field acts on the magnetic beads 3 to which the nucleic acids are adsorbed, and the magnetic beads 3 are magnetically attracted. Accordingly, the magnetic beads 3 are moved to and fixed to the inner wall of the container 9. As a result, the magnetic beads 3 in the solid phase can be separated from the liquid phase. FIGS. 5 and 6 show a state in which the magnetic beads 3 are fixed to a part of an inner wall surrounding the second axis AX2 when the container 9 is a cylindrical microtube extending along the second axis AX2.

The magnetic separation step S104 and the liquid discharge step S106, which will be described later, are performed after the lysis and binding step S102, and also in a washing step S108 and an elution step S110, which will be described later, as necessary.

Before the magnetic attraction is performed, the contents contained in the container 9 are stirred as necessary. Accordingly, probability that the nucleic acids are adsorbed to the magnetic beads 3 is increased. For the stirring, for example, a vortex mixer and hand shaking are used.

After the magnetic attraction is performed, an acceleration may be applied to the container 9 as necessary. Accordingly, a liquid adhering to the magnetic beads 3 can be shaken off, so that accuracy of the magnetic separation can be improved. The acceleration may be a centrifugal acceleration. To apply the centrifugal acceleration, a centrifugal separator may be used.

In the magnetic separation step S104, as described above, the magnetic field is applied to the contents in the container 9. This means that, when the magnetic field is represented by the magnetic field lines Lm, the magnetic field is generated such that the magnetic field lines Lm pass through an inside of the container 9, as shown in FIGS. 5 and 6. A density of the magnetic field lines Lm represents a strength of the magnetic field. Further, the magnetic beads 3 move when there is a difference in the strength of the magnetic field in a space, that is, according to a gradient of the strength of the magnetic field.

In FIGS. 5 and 6, the magnet 124 is a magnetic field generation device, and the magnetic field is stronger as the magnetic field is closer to magnetic poles of the magnet 124. Therefore, the magnetic beads 3 move toward the magnet 124 and are fixed to the inner wall close to the magnet 124. As described above, as shown in FIG. 5, the magnetic beads 3 and a liquid 4 can be separated from each other. Thereafter, in the liquid discharge step S106 to be described later, the liquid 4 in the container 9 is discharged by a solution binding tool such as a pipette in a state in which the magnetic beads 3 are fixed to the inner wall of the container 9.

Here, in the embodiment, the magnetic field is set to satisfy the following two factors (a) and (b).
(a) The magnetic poles that generate the magnetic field face directions different from that of the container 9.
(b) When the magnetic field lines Lm are projected onto a plane including the second axis AX2 of the container 9, an angle formed by the second axis AX2 and the projected magnetic field line Lm′ is more than 0° and 90° or less.

By satisfying the two factors (a) and (b), the problem in the related art can be solved. The reason for this will be described below.

### 2.2.1. Factor (a)

In FIGS. 5 and 6, the magnetic poles that generate the magnetic field face directions different from that of the container 9. Specifically, in FIGS. 5 and 6, the magnet 124, which is an example of the magnetic field generation device, is shown. When the magnet 124 is taken as a reference, the container 9 is located on an X-axis minus side. Meanwhile, FIG. 5 shows the N pole of the magnet 124. The N pole faces the Y-axis minus side which is a direction different from that of the container 9. In FIG. 6, the N pole and the S pole are shown. The N pole faces the Y-axis minus side. The S pole faces the Y-axis plus side. Therefore, in FIGS. 5 and 6, the direction of the magnetic field is set to satisfy the above factor (a). The direction different from that of the container 9 refers to, for example, a direction in which, when a direction of the magnetization of the magnet 124 is extended, an extended line thereof is deviated from the container 9.

By satisfying the above factor (a), it is possible to prevent occurrence of a spike phenomenon, which is the problem in the related art. The spike phenomenon occurs when the magnetic poles that generate the magnetic field are close to the container 9 and the magnetic field lines Lm are distributed at a high density. By satisfying factor (a), the magnetic poles are likely to be away from the container 9. In this way, an increase in the density of the magnetic field lines Lm passing through the container 9 can be prevented. As a result, the spike phenomenon is less likely to occur, and the separability in the magnetic separation can be improved.

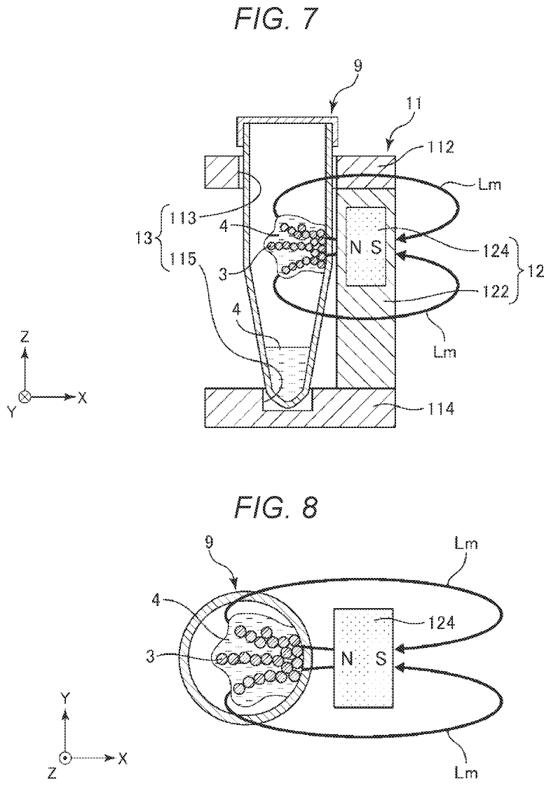

In contrast, FIGS. 7 and 8 are schematic views showing an example in which the direction of the magnetic field applied to the container 9 is set to the direction of the container 9 (an example in which factor (a) is not satisfied).

In FIGS. 7 and 8, the magnetic poles that generate the magnetic field face the direction of the container 9. That is, in FIGS. 7 and 8, the magnetic field does not satisfy factor (a). Specifically, in FIGS. 7 and 8, the N pole faces the X-axis minus side, which is the direction of the container 9. Therefore, the density of the magnetic field lines Lm passing through the container 9 is likely to increase. As a result, the magnetic beads 3 are arranged in a needle shape, and the spike phenomenon occurs.

### 2.2.2. Factor (b)

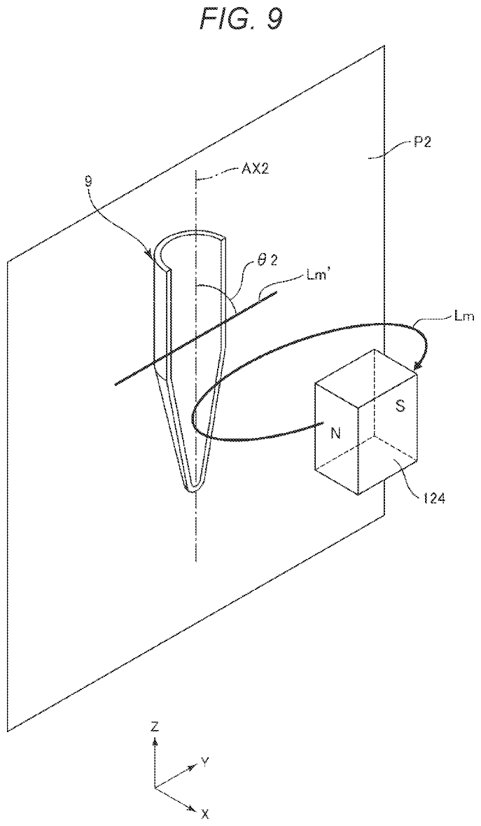

FIG. 9 is a schematic view showing an angle θ2 formed by the second axis AX2 and a projected magnetic field line Lm′ when the magnetic field lines Lm are projected onto a plane P2 including the second axis AX2 of the container 9. When the container 9 has a cylindrical shape, the second axis AX2 of the container 9 refers to an axis of the cylinder. In the example shown in FIG. 9, the angle θ2 is 90°. Therefore, in FIG. 9, the magnetic field is set to satisfy factor (b).

When the angle θ2 is 90°, the magnetic field lines Lm passing through the container 9 spread along the X-Y plane orthogonal to the second axis AX2, as shown in FIGS. 5 and 6. In this way, as shown in FIG. 6, the magnetic poles (the N pole and the S pole of the magnet 124) serving as a starting point and an end point of the magnetic field lines Lm are located at positions away from the container 9 in accordance with a cross-sectional shape (an annular shape) of the container 9 taken along the X-Y plane. In this way, a distance between the contents contained in the container 9 and the magnetic poles naturally increases. Therefore, the occurrence of the spike phenomenon is prevented.

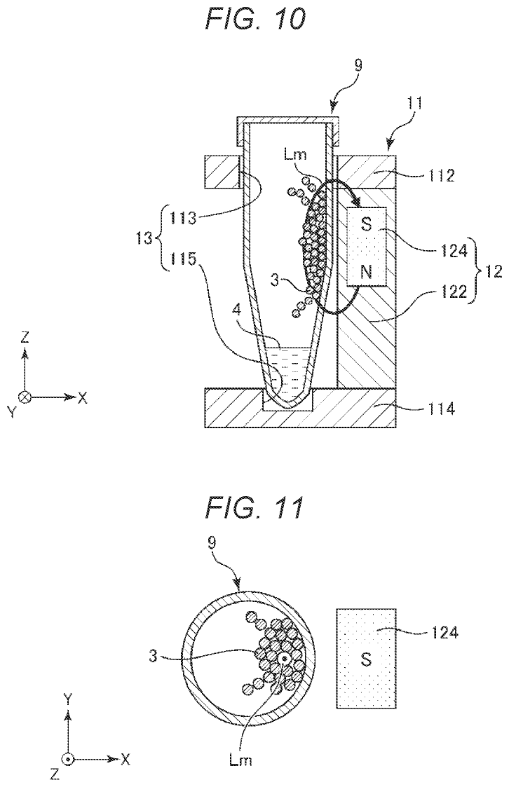

In contrast, FIGS. 10 and 11 are schematic views showing an example in which the angle θ2 formed by the second axis AX2 and the projected magnetic field line Lm′ is 0° when the magnetic field lines Lm are projected onto the plane P2 including the second axis AX2 of the container 9 (an example in which factor (b) is not satisfied).

In FIGS. 10 and 11, since the angle θ2 is 0°, factor (b) is not satisfied. When the angle θ2 is 0°, the magnetic field lines Lm passing through the container 9 spread along a plane including the second axis AX2, for example, the X-Z plane, as shown in FIGS. 10 and 11. In this way, as shown in FIG. 10, the magnetic poles serving as the starting point and the end point of the magnetic field lines Lm are likely to approach the container 9 in accordance with the cross-sectional shape of the container 9 taken along the X-Z plane. In this way, since the distance between the contents contained in the container 9 and the magnetic poles is naturally brought close, the spike phenomenon is likely to occur particularly at a position close to the magnetic poles.

As described above, the angle θ2 is not limited to 90°, and may be any angle more than 0° and 90° or less. In this case as well, it is possible to prevent the occurrence of the spike phenomenon as compared with the case of 0°. The angle θ2 is an angle formed by the second axis AX2 and the projected magnetic field line Lm′, and is an angle formed on the Y-axis plus side and a Z-axis plus side in the example of FIG. 9. The angle θ2 is not limited to the angle formed at the position shown in FIG. 9, and is taken as an angle of 90° or less among the angles formed by the second axis AX2 and the projected magnetic field line Lm′. Therefore, when the angle θ2 shown in FIG. 9 is more than 90°, an acute angle adjacent to the obtuse angle may be set as the angle θ2.

The angle θ2 is preferably 60° or more and 90° or less, and more preferably 75° or more and 90° or less. Accordingly, it is possible to more reliably prevent the occurrence of the spike phenomenon, and thus it is possible to particularly improve the separability in the magnetic separation.

### 2.2.3. Effects of Factors (a) and (b)

As described above, by satisfying both the two factors (a) and (b), it is possible to prevent the occurrence of the spike phenomenon, which is the problem in the related art. By preventing the occurrence of the spike phenomenon, the separability in the magnetic separation can be improved.

FIGS. 7 and 8 show typical arrangements of the magnetic beads 3 in which the spike phenomenon occurs. When the spike phenomenon occurs, since the magnetic beads 3 are arranged in the needle shape, a gap is likely to be formed between the magnetic beads 3. When the liquid 4 enters the gap, the liquid 4 is less likely to come out. In this way, even if the magnetic beads 3 are fixed to the inner wall of the container 9, a large amount of the liquid 4 remains between the magnetic beads 3 due to surface tension (a large amount of residual liquid is generated). As a result, the separability between the magnetic beads 3 and the liquid 4 in the magnetic separation is reduced. The liquid 4 contains, for example, a chaotropic substance. Since the liquid 4 remaining between the magnetic beads 3 is less likely to be discharged by a pipette or the like, the liquid 4 is likely to be brought into the washing step S108 or the elution step S110 described later. In this way, the chaotropic substance may affect the nucleic acids to be finally extracted, and purity of the nucleic acids may be reduced.

On the other hand, when the occurrence of the spike phenomenon is prevented, the gap is less likely to be formed between the magnetic beads 3. Accordingly, the separability between the magnetic beads 3 and the liquid 4 in the magnetic separation is improved. As a result, high-purity nucleic acids can be finally extracted.

As shown in FIG. 6, the magnetic beads 3 in which the occurrence of the spike phenomenon is prevented are likely to be compacted in the container 9. In other words, as shown in FIG. 8, the magnetic beads 3 in which the spike phenomenon occurs spread to largely protrude in the container 9. Such protrusion is prevented.

When the liquid 4 after the magnetic separation is discharged by a pipette or the like, the magnetic beads 3 shown in FIG. 8 may interfere with the pipette or the like and may hinder a discharge operation. On the other hand, since the magnetic beads 3 shown in FIG. 6 are less likely to interfere with the pipette or the like, the discharge operation is less likely to be hindered.

### 2.2.4. Magnetic Stand for Generating Magnetic Field Satisfying Factors (a) and (b)

The magnetic field satisfying the above-described factors (a) and (b) can be generated by the magnetic stand 1 shown in FIGS. 1 to 3.

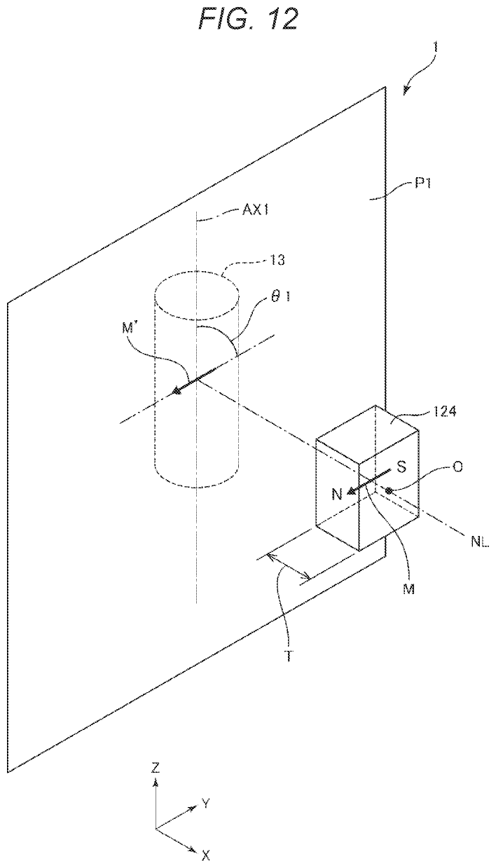

FIG. 12 is a schematic view showing an angle θ1 formed by the first axis AX1 and a projected magnetization M′ when a magnetization M of the magnet 124 is projected onto the plane P1 including the first axis AX1 of the insertion hole 13 of the magnetic stand 1. When the insertion hole 13 has a tubular shape, the first axis AX1 of the insertion hole 13 refers to an axis of the tube. In the example shown in FIG. 12, the angle θ1 is 90°.

When the angle θ1 is 90°, the magnetic field lines Lm passing through the container 9 inserted into the insertion hole 13 have patterns shown in FIGS. 5 and 6. In this way, as shown in FIG. 12, the magnet 124 that generates the magnetic field lines Lm is disposed such that the N pole and the S pole face directions different from that of the container 9. Therefore, the magnetic field applied to the container 9 by the magnetic stand 1 can satisfy the above factor (a).

When the angle θ1 shown in FIG. 12 is 90°, the angle θ2 shown in FIG. 9 is also 90°. Specifically, when the container 9 is inserted into the insertion hole 13, the container 9 is held such that the first axis AX1 of the insertion hole 13 and the second axis AX2 of the container 9 are substantially parallel to each other. Therefore, the magnetic field applied to the container 9 by the magnetic stand 1 can satisfy the above factor (b).

The plane P1 is a plane including the first axis AX1, and is a plane determined such that a normal line NL is orthogonal to the first axis AX1 and passes through a center O of the magnet 124, as shown in FIG. 12. The center O of the magnet 124 is a midpoint between the N pole and the S pole.

The angle θ1 is not limited to 90°, and may be any angle more than 0° and 90° or less. In this case as well, it is possible to prevent the occurrence of the spike phenomenon as compared with the case of 0°. The angle θ1 is an angle formed by the first axis AX1 and the projected magnetization M′, and is an angle formed on the Y-axis plus side and the Z-axis plus side in the example of FIG. 12. The angle θ1 is not limited to the angle formed at the position shown in FIG. 12, and is set to an angle of 90° or less among the angles formed by the first axis AX1 and the projected magnetization M′. Therefore, when the angle θ1 shown in FIG. 12 is more than 90°, an acute angle adjacent to the obtuse angle may be set as the angle θ1.

The angle θ1 is preferably 60° or more and 90° or less, and more preferably 75° or more and 90° or less. Accordingly, it is possible to more reliably prevent the occurrence of the spike phenomenon, and thus it is possible to particularly improve the separability in the magnetic separation.

The direction of the magnetization M of the magnet 124 is preferably parallel to the plane P1. Accordingly, since the distance between the two magnetic poles and the container 9 is substantially equal, it is possible to prevent one of the magnetic poles and the container 9 from coming too close to each other. As a result, it is possible to more reliably prevent the occurrence of the spike phenomenon.

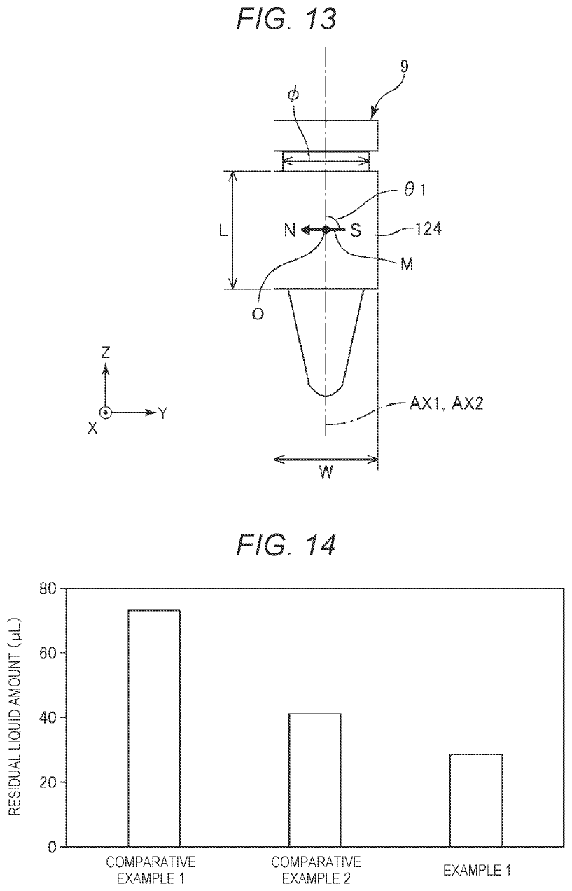

FIG. 13 is a diagram of the container 9 inserted into the insertion hole 13 shown in FIG. 12 when viewed from the magnet 124.

The size of the magnet 124 is appropriately set according to the size of the container 9. In FIG. 13, when viewed from the normal line NL shown in FIG. 12, a diameter of the container 9 at the position where the magnet 124 is provided is denoted by φ, a width of the magnet 124 is denoted by W, and a length of the magnet 124 is denoted by L. The width W of the magnet 124 is the width of the magnet 124 in the direction of the magnetization M. The length L of the magnet 124 is the length of the magnet 124 in a direction orthogonal to the magnetization M.

When the diameter φ, of the container 9 is taken as 1, a relative value of the width W of the magnet 124 is preferably 0.2 or more and 1.5 or less, more preferably 0.3 or more and 1.0 or less, and still more preferably 0.4 or more and 0.8 or less. Accordingly, the distance between the magnetic poles of the magnet 124 and the container 9 can be appropriately increased, and a volume of the magnet 124 required to generate a magnetic field with sufficient strength can be secured. As a result, it is possible to sufficiently increase the moving speed of the magnetic beads 3 while preventing the occurrence of the spike phenomenon and improving the separability in the magnetic separation. It is possible to prevent the size of the magnet 124 from being increased more than necessary, and to reduce the size and the weight of the magnetic stand 1. When the relative value of the width W is less than a lower limit value, the volume of the magnet 124 cannot be sufficiently secured, and the surface magnetic flux density of the magnet 124 may be insufficient. On the other hand, when the relative value of the width W exceeds an upper limit value, the magnetic poles and the container 9 are excessively away from each other, and the moving speed of the magnetic bead 3 may be reduced.

As an example, the width W of the magnet 124 is preferably 3 mm or more and 20 mm or less, and more preferably 4 mm or more and 12 mm or less.

As an example, the length L of the magnet 124 is preferably 3 mm or more and 40 mm or less, and more preferably 4 mm or more and 15 mm or less. Accordingly, it is possible to maintain a balance between the width W and the length L while securing the volume of the magnet 124 necessary for generating the magnetic field having the sufficient strength, and it is possible to prevent an increase in the residual liquid amount caused by excessive expansion of a range of the magnetic poles in the Z-axis direction and an increase in the gap between the magnetic beads 3.

As an example, a thickness T of the magnet 124 is preferably 2 mm or more and 20 mm or less, and more preferably 3 mm or more and 10 mm or less.

As an example, a shortest distance between the magnet 124 and the container 9 is preferably 10 mm or less, and more preferably 0.5 mm or more and 6 mm or less.

### 2.3. Liquid Discharge Step

In the liquid discharge step S106, the liquid 4 in the container 9 is discharged by a pipette or the like in a state in which the magnetic beads 3 are fixed to the inner wall of the container 9. Accordingly, the liquid 4 containing the chaotropic substance or the like can be separated from the nucleic acids adsorbed to the magnetic beads 3.

### 2.4. Washing Step

In the washing step S108, the magnetic beads 3 on which the nucleic acids are adsorbed are washed. The washing refers to an operation of removing impurities by bringing the magnetic beads 3, on which the nucleic acids are adsorbed, into contact with a washing liquid and then separating the magnetic beads 3 from the washing liquid again in order to remove the impurities adsorbed on the magnetic beads 3.

Specifically, in the state in which the magnetic beads 3 are fixed to the inner wall of the container 9 by the external magnetic field, the washing liquid is supplied into the container 9 by a pipette or the like. Then, the magnetic beads 3 and the washing liquid are stirred. Accordingly, the washing liquid is brought into contact with the magnetic beads 3, and the magnetic beads 3 on which the nucleic acids are adsorbed are washed. For the stirring, for example, a vortex mixer and hand shaking are used. At this time, the external magnetic field may be temporarily removed. Accordingly, the magnetic beads 3 are dispersed in the washing liquid, so that the washing efficiency can be further improved.

Next, the external magnetic field acts on the magnetic beads 3 again to fix the magnetic beads 3 to the inner wall of the container 9, and then the washing liquid is discharged. By repeating supply and discharge of the washing liquid as described above one or more times, the magnetic beads 3 are washed. Accordingly, impurities excluding the nucleic acids can be removed with high accuracy.

The washing liquid is not particularly limited as long as it is a liquid that does not promote elution of the nucleic acids and does not promote binding of impurities to the magnetic beads 3. Examples thereof include organic solvents such as ethanol, isopropyl alcohol, and acetone, aqueous solutions of the organic solvents, and a low salt concentration aqueous solution. Examples of the low salt concentration aqueous solution include a buffer solution. A salt concentration in the low salt concentration aqueous solution is preferably 0.1 mM or more and 100 mM or less, and more preferably 1 mM or more and 50 mM or less. A salt for the buffer solution is not particularly limited, and a salt such as TRIS, HEPES, PIPES, and phosphoric acid is preferably used.

The washing liquid may contain a surfactant such as Triton (registered trademark), Tween (registered trademark), or SDS. The washing liquid may contain a chaotropic substance such as guanidine hydrochloride. A pH of the washing liquid is not particularly limited.

The washing step S108 may be performed as necessary and may be omitted when washing is not necessary.

Further, in the washing step S108, the same operations as those in the magnetic separation step S104 and the liquid discharge step S106 described above, that is, the magnetic separation method according to the embodiment can also be performed. Accordingly, it is possible to prevent a large amount of washing liquid from remaining on the fixed magnetic beads 3. As a result, it is possible to prevent the washing liquid or a component thereof from being transferred to the elution step S110.

### 2.5. Elution Step

In the elution step S110, the nucleic acids adsorbed on the magnetic beads 3 are eluted into an eluate. The elution is an operation of transferring the nucleic acids to the eluate by bringing the magnetic beads 3 on which the nucleic acids are adsorbed into contact with the eluate and then separating the magnetic beads from the eluate again.

Specifically, first, the eluate is supplied into the container 9 by a pipette or the like. Then, the magnetic beads 3 and the eluate are stirred. Accordingly, the eluate is brought into contact with the magnetic beads 3, and the nucleic acids can be eluted. For the stirring, for example, a vortex mixer and hand shaking are used. At this time, the external magnetic field may be temporarily removed. Accordingly, the magnetic beads 3 are dispersed in the eluate, so that elution efficiency can be further improved.

Next, the external magnetic field acts on the magnetic beads 3 again to fix the magnetic beads 3 to the inner wall of the container 9, and then the eluate into which the nucleic acids are eluted is discharged. Accordingly, the nucleic acids can be recovered.

The eluate is not particularly limited as long as it is a liquid that promotes the elution of the nucleic acids from the magnetic beads 3 on which the nucleic acids are adsorbed. For example, in addition to water such as sterilized water or pure water, a TE buffer solution, that is, an aqueous solution containing 10 mM of Tris-HCl buffer solution and 1 mM of EDTA and having a pH of about 8 is preferably used.

The eluate may contain a surfactant such as Triton (registered trademark), Tween (registered trademark), or SDS. The eluate may contain sodium azide as a preservative.

In the elution step S110, the eluate may be heated. Accordingly, the elution of the nucleic acids can be promoted. A heating temperature for the eluate is not particularly limited, and is preferably 70° C. or higher and 200° C. or lower, more preferably 80° C. or higher and 150° C. or lower, and still more preferably 95° C. or higher and 125° C. or lower.

Examples of a heating method include a method of supplying an eluate heated in advance, and a method of supplying an unheated eluate into a container and then heating the eluate. A heating time is not particularly limited, and may be 30 seconds or more and 10 minutes or less.

The elution step S110 may be performed as necessary. For example, when the purpose is only to separate the magnetic beads 3 from the liquid 4 in the magnetic separation step S104, the elution step S110 may be omitted.

Further, in the elution step S110, the same operations as those in the magnetic separation step S104 and the liquid discharge step S106 described above, that is, the magnetic separation method according to the embodiment can also be performed. Accordingly, it is possible to prevent a large amount of nucleic acids from remaining on the fixed magnetic beads 3. As a result, a decrease in a yield of nucleic acids can be prevented.

### 3. Effects of Embodiment

As described above, the magnetic stand 1 according to the embodiment includes the stand 11 (base) and the magnet 124. The stand 11 has the insertion hole 13 into which the container 9 is to be inserted. The insertion hole 13 extends along the first axis AX1. The magnet 124 is provided in the stand 11 and has the magnetization M that applies the magnetic field to the insertion hole 13.

Further, the magnet 124 is disposed such that the magnetic poles thereof face directions different from that of the container 9. As shown in FIG. 12, when the plane P1 including the first axis AX1 of the insertion hole 13 is set as the reference plane and the magnetization M is projected onto the plane P1, the angle θ1 formed by the first axis AX1 and the magnetization M′ projected onto the plane P1 is more than 0° and 90° or less. The plane P1 is a plane determined such that the normal line NL thereof is orthogonal to the first axis AX1 and passes through the center O of the magnet 124.

According to such a configuration, it is possible to prevent the occurrence of the spike phenomenon in the magnetic beads 3 accommodated in the container 9. Accordingly, it is possible to prevent a large amount of the liquid 4 from remaining on the magnetic beads 3 even after the magnetic separation. As a result, the separability in the magnetic separation can be improved. Accordingly, for example, when the nucleic acids are extracted from a sample using the magnetic separation, high-purity nucleic acids can be extracted at a high yield.

The angle θ1 described above is preferably 60° or more and 90° or less. Accordingly, it is possible to more reliably prevent the occurrence of the spike phenomenon.

When the container 9 is inserted into the insertion hole 13 and the diameter φ of the container 9 measured at the position where the magnet 124 is provided is 1, the width of the magnet 124 in the direction of the magnetization M is preferably 0.2 or more and 1.5 or less. Accordingly, the distance between the magnetic poles of the magnet 124 and the container 9 can be appropriately increased, and a volume of the magnet 124 required to generate a magnetic field with sufficient strength can be secured. As a result, it is possible to sufficiently increase the moving speed of the magnetic beads 3 while preventing the occurrence of the spike phenomenon and improving the separability in the magnetic separation.

The magnet 124 is preferably a permanent magnet. Accordingly, the power supply for the magnetic stand 1 is unnecessary, and the size reduction and the weight reduction are facilitated. Since the portability of the magnetic stand 1 is improved, the degree of freedom of an installation place is increased.

The magnetic separation method according to the embodiment includes the magnetic separation step S104 and the liquid discharge step S106. In the magnetic separation step S104, the magnetic beads 3 and the liquid 4 are separated from each other by applying the magnetic field to the container 9 containing the magnetic beads 3 and the liquid 4 to fix the magnetic beads 3 to the inner wall of the container 9. In the liquid discharge step S106, the liquid 4 is discharged by the solution binding tool in a state in which the magnetic beads 3 and the liquid 4 are separated from each other. Further, the magnetic poles that generate the magnetic field face directions different from that of the container 9. The magnetic field is set such that, when the axis of the container 9 is taken as the second axis AX2 and the magnetic field lines Lm representing the magnetic field are projected on the plane P2 including the second axis AX2, the angle θ2 formed by the projected magnetic field line Lm′ and the second axis AX2 is more than 0° and 90° or less.

According to such a configuration, it is possible to prevent the occurrence of the spike phenomenon in the magnetic beads 3 accommodated in the container 9. Accordingly, it is possible to prevent a large amount of the liquid 4 from remaining on the magnetic beads 3 even after the magnetic separation. As a result, the separability in the magnetic separation can be improved. Accordingly, for example, when the nucleic acids are extracted from a sample using the magnetic separation, high-purity nucleic acids can be extracted at the high yield.

The angle θ2 described above is preferably 60° or more and 90° or less. Accordingly, it is possible to more reliably prevent the occurrence of the spike phenomenon.

Although the magnetic stand and the magnetic separation method according to the present disclosure are described based on the shown embodiment, the present disclosure is not limited thereto. For example, the magnetic separation method according to the present disclosure may be a method in which a step for any purpose is added to the above-described embodiment. In the magnetic stand according to the present disclosure, each part of the above-described embodiment may be replaced with any configuration having the same function, or any configuration may be added to the above-described embodiment.

### EXAMPLES

Next, specific examples of the present disclosure will be described.

### 4. Nucleic Acid Extraction by Magnetic Separation

### 4.1. Example 1

First, as the lysis and binding step, 100 μL of a dispersion liquid containing Hela cells, 40 μL of a magnetic bead dispersion liquid, and a lysis and binding solution were put into a container (a microtube whose diameter φ is 10.5 mm), and stirred for 10 minutes by a vortex mixer. An aqueous solution containing guanidine hydrochloride was used as the lysis and binding solution. As the magnetic beads, a magnetic powder with a coating film including a Fe—Al—Si—B-based alloy magnetic powder and a silica film coating a particle surface thereof was used. An average particle diameter of the magnetic beads was 3.3 μm.

Next, as the magnetic separation step, magnetic separation (B/F separation) was performed by the magnetic stand shown in FIGS. 5 and 6. The magnetic stand used a neodymium iron boron magnet. The width W of the magnet was 5 mm, the length L of the magnet was 10 mm, the thickness T of the magnet was 5 mm, and a shortest distance between the magnet and the container was 1 mm. Subsequently, as the liquid discharge step, a supernatant in a liquid phase was discharged with a pipette.

Next, the washing step was performed according to the following procedure.

First, 900 μL of a first washing liquid was put into the container and stirred for 5 seconds. Subsequently, as the magnetic separation step, the magnetic separation was performed by the magnetic stand shown in FIGS. 5 and 6. Subsequently, as the liquid discharge step, the supernatant was discharged. Thereafter, these washing operations were repeated a plurality of times.

Next, 900 μL of a second washing liquid was put into the container and stirred for 5 seconds. Subsequently, as the magnetic separation step, the magnetic separation was performed by the magnetic stand shown in FIGS. 5 and 6. Subsequently, as the liquid discharge step, the supernatant was discharged. Thereafter, these washing operations were repeated a plurality of times.

Next, the elution step was performed by the following procedure.

First, 100 μL of sterilized water as an eluate was put into the container and stirred for 10 minutes. Subsequently, as the magnetic separation step, the magnetic separation was performed by the magnetic stand shown in FIGS. 5 and 6. Subsequently, as the liquid discharge step, the supernatant was discharged. As described above, a nucleic acid extract was obtained.

### 4.2. Example 2

A nucleic acid extract was obtained in the same manner as in Example 1 except that the length L of the magnet was changed to 5 mm.

### 4.3. Example 3

A nucleic acid extract was obtained in the same manner as in Example 1 except that the length L of the magnet was changed to 20 mm.

### 4.4. Example 4

A nucleic acid extract was obtained in the same manner as in Example 1 except that the length L of the magnet was changed to 5 mm and the width W of the magnet was changed to 10 mm.

### 4.5. Example 5

A nucleic acid extract was obtained in the same manner as in Example 1 except that the width W of the magnet was changed to 10 mm.

### 4.6. Comparative Example 1

A nucleic acid extract was obtained in the same manner as in Examples except that the magnetic stand shown in FIGS. 7 and 8 was used. The length of the magnet in the Z-axis direction was 10 mm, the width in the Y-axis direction was 5 mm, the thickness in the X-axis direction was 5 mm, and the shortest distance between the magnet and the container was 1 mm.

### 4.7. Comparative Example 2

A nucleic acid extract was obtained in the same manner as in Examples except that the magnetic stand shown in FIGS. 10 and 11 was used. The length of the magnet in the Z-axis direction was 3 mm, the width in the Y-axis direction was 5 mm, the thickness in the X-axis direction was 4 mm, and the shortest distance between the magnet and the container was 1 mm.

### 5. Evaluation of Separability in Magnetic Separation

### 5.1. Relationship Between Direction of Magnetic Field and Separability

In the magnetic separation in Example 1 and Comparative Examples, the separability was evaluated by the following procedure.

First, after the completion of the washing step, a weight of the container containing the contents was measured. The contents are the magnetic beads and the liquid (residual liquid) adhering thereto. A measurement result of the weight is referred to as “weight after magnetic separation”.

Next, the weight of the container alone and the weight of the magnetic beads put into the container in the lysis and binding step were subtracted from the weight after magnetic separation. Since a subtraction result corresponds to a weight of the residual liquid described above, the subtraction result is referred to as a “residual liquid weight”. Thereafter, a volume of the residual liquid was calculated from the residual liquid weight. A calculation result is referred to as a “residual liquid amount”. A graph was created in order to compare the calculated residual liquid amounts in Example 1 and Comparative Examples. The created graph is shown in FIG. 14.

As shown in FIG. 14, in the magnetic separation in Example 1, the residual liquid amount was reduced to be smaller than the magnetic separation in Comparative Examples 1 and 2. In the magnetic separation in Example 1, the spike phenomenon was less likely to occur in the magnetic beads. However, in the magnetic separation in Comparative Examples 1 and 2, the spike phenomenon was observed. Therefore, it is considered that the direction of the magnetic field generated from the magnet and the spike phenomenon hence generated are related to the reduction of the residual liquid amount.

### 5.2. Relationship Between Size of Magnet and Separability

In the magnetic separation in Examples 1 to 5, the separability was evaluated by the following procedure.

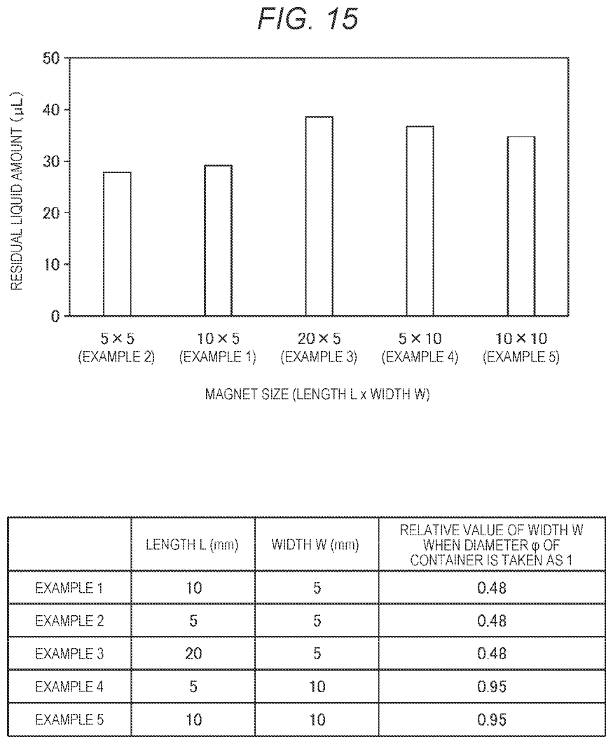

First, the residual liquid amount was calculated in the same manner as in 5.1. Next, a graph was created in order to compare the calculated residual liquid amounts in Examples 1 to 5. The created graph is shown in FIG. 15. FIG. 15 also shows a table showing sizes of magnets used in Examples 1 to 5.

As shown in FIG. 15, in the magnetic separation in Examples 1 and 2, the residual liquid amounts were reduced as compared with that in the magnetic separation in Examples 3 to 5. This is considered to be due to the fact that the sizes of the magnets used in Examples 1 and 2 were optimized for the container (the microtube whose diameter p is 10.5 mm).

What is claimed is:

1. A magnetic stand comprising:
a base having an insertion hole into which a container is to be inserted, the insertion hole extending along a first axis; and
a magnet provided on the base and having a magnetization that applies a magnetic field to the insertion hole, wherein
the magnet is disposed such that magnetic poles thereof face directions different from that of the container, and
when a plane including the first axis and determined such that a normal line of the plane is orthogonal to the first axis and passes through a center of the magnet is taken as a reference plane, and the magnetization is projected onto the reference plane,
an angle formed by the first axis and the magnetization projected onto the reference plane is more than 0° and 90° or less.

2. The magnetic stand according to claim 1, wherein
the angle is 60° or more and 90° or less.

3. The magnetic stand according to claim 2, wherein
when the container is inserted into the insertion hole and a diameter of the container measured at a position where the magnet is provided is taken as 1,
a width of the magnet in a direction of the magnetization is 0.2 or more and 1.5 or less.

4. The magnetic stand according to claim 1, wherein
the magnet is a permanent magnet.

5. A magnetic separation method comprising:
a magnetic separation step of separating magnetic beads from a liquid by applying a magnetic field to a container containing the magnetic beads and the liquid to fix the magnetic beads to an inner wall of the container; and
a liquid discharge step of discharging the liquid by a solution binding tool in a state in which the magnetic beads and the liquid are separated from each other, wherein
magnetic poles that generate the magnetic field face directions different from that of the container, and
the magnetic field is set such that, when an axis of the container is taken as a second axis and magnetic field lines representing the magnetic field are projected onto a plane including the second axis,
an angle formed by a projected magnetic field line and the second axis is more than 0° and 90° or less.

6. The magnetic separation method according to claim 5, wherein
the angle is 60° or more and 90° or less.
